(19) United States
(12) Patent Application Publication
(10) Pub. No.: US 2008/0151443 A1
(43) Pub. Date: Jun. 26, 2008

(54) A/V Media Distribution in a Power Center

(75) Inventors: Noel Lee, Las Vegas, NV (US); Demian Martin, San Leandro, CA (US); Anthony Dichiro, Chatsworth, CA (US)

Correspondence Address: LARIVIERE, GRUBMAN & PAYNE, LLP, 19 UPPER RAGSDALE DRIVE, SUITE 200, MONTEREY, CA, 93940, US

(73) Assignee: Monster Cable Products, Inc., Brisbane, CA (US)

(21) Appl. No.: 11/969,870

(22) Filed: Jan. 4, 2008

Related U.S. Application Data
(63) Continuation-in-part of application No. PCT/US06/62761, filed on Dec. 29, 2006.
(60) Provisional application No. 60/755,563, filed on Dec. 29, 2005.

(51) Int. Cl. H02H 3/00; H02H 7/00

(52) U.S. Cl. 361/1

(57) ABSTRACT

An apparatus 100 for protecting electrical products, consumer electronics devices in particular, from A/C voltage problems while providing enhanced wireless or wired networking data functionality. Apparatus 100 transmits data signals on AC power lines and routes them around selected power protection components to outlets for connecting with the electronic devices. Apparatus 100 delivers analog and/or digital high resolution media from an Internet protocol home or world network.

The present application is a continuation-in-pail of and claims priority to International Application Number PCT/US06/62761, filed Dec. 29, 2006, which in turn claims priority to U.S. patent application Ser. No. 60/755,563 filed Dec. 29, 2005.

### FIELD OF THE INVENTION

The present invention relates to consumer electronic products. More particularly, the present invention relates to electrical power protection of consumer electronics products. Even more specifically, the present invention relates to increased data communications functionality and enhanced electrical power protection of consumer electronics devices.

### BACKGROUND OF THE INVENTION

Currently, consumer electronic products such as audio/video (AV) receivers and amplifiers are subjected to alternating current (AC) power fluctuations, noise, spurious signal and voltage surges, and other inconsistencies which can directly impact audio quality and product longevity. While power protection devices are known in the industry, these devices have not taken into account the changing role and functionality of the protected electronic products. Traditional power filters and line conditioner protection devices will reduce voltage transients and fluctuations, but are unable to accommodate data communication over the AC power line, since the data carried over the power line can be inadvertently blocked as AC power line noise. A growing problem with current power protection technology has to do with accounting for and accommodating desired data bandwidth while preserving power protection functionality.

### BRIEF SUMMARY OF THE INVENTION

Accordingly, the present invention addresses this long-felt need for an AV capable network power center which not only protects the attached consumer electronic products (herein “product”), such as an AV unit or television, but also acts as a data gateway for such attached products. Generally, the present invention involves enhancing the functionality of an AV network power center by abating unacceptable power conditions while simultaneously providing improved data-specific functionality of the consumer electronic products connected thereto.

By incorporating a capability for AV content distribution via networking as a component feature of a device, a variety of benefits are obtained. Primarily, in addition to power protecting of connected products, the protection system detailed herein as the improved power center will avoid the undesired blocking of the data signals from power line networking.

Personal computer-based products for integration with home theater systems are already available in the consumer marketplace. Such devices further increase the need for incorporating a power protection system to filter the power for the home theater personal computer as well as the AV receiver, DVD player, and other devices. To maximize functionality, the personal computer requires an Internet connection to provide content information such as MP3 artist and title information. Should the user access the Internet through a home power network, traditional power filtering will block the Internet communication as unwanted noise. In the present invention and related method, however, the networking signals are routed around the power filtering capabilities and provided to the destination product, thus improving the present state of power filtering capabilities. As a direct consequence, home theater personal computers and other devices which access Internet or network content can be power-protected while still retrieving Internet content such as media information, streaming audio and video as well as other content on demand.

While one embodiment provides for simple data routing, other variants can include incorporating dedicated data decoding functionality within the enhanced power center device. By bundling data decoding capacity into the AV power interface, legacy devices not traditionally designed for Internet data can acquire new functionality. With Internet streams often incorporating video as well as audio data, older video projectors can still display video data once decoded and translated into a recognizable format such as NTSC, PAL and HDTV. As for audio formats, streaming MP3 Internet radio broadcasts or podcasts can be readily converted from Internet data to audio formats which traditional receivers can then reproduce from digital down to the level of analog audio output. As a result, older products that do not have any kind of built in networking capability can acquire enhanced capabilities so that all such products will have a common point connection to receive data input as well as AC power. Such communication is traditionally bidirectional, but can be implemented as unidirectional when design choices dictate.

Among the advantages of the present invention is expanded data transmission functionality while preserving power protection capabilities. Another advantage is that an AV power interface constructed according to the principles of the present invention could be assembled using standard components connected through standard interfaces. There is no special aspect of the interconnection of the devices.

The following description of the invention is in terms of a powerline network but the invention can use any network medium. The exemplary embodiments provided herein are not intended to limit the present invention to only those embodiments. Features described in reference to the embodiments may be combined in any combination within the scope of the present invention. Other features of the present invention are disclosed, or are apparent, in the section entitled “Detailed Description of Selected Embodiments.”

### BRIEF DESCRIPTION OF THE DRAWING

For a better understanding of the present invention, reference is made to the below-referenced accompanying drawing. Reference numbers refer to the same or equivalent parts of the present invention throughout the several figures of the drawing.

FIG. 1 is a front view of device 100.

FIG. 2 is an exploded top view of device 200 with WiFi functionality.

FIG. 3 is a front perspective view of device 300 with advanced power monitoring functionality.

FIG. 4 illustrates the device 400 in conjunction with IR repeater controlled ancillary components.

FIG. 5 is a detail of an exemplary embodiment of the device of FIG. 2.

FIG. 6 is a detail of another exemplary embodiment of the device of FIG. 2.

FIG. 7 is an exemplary circuit of the AC filter and protection module of the embodiment of FIG. 6.

FIG. 8A is a block diagram of an exemplary system using the AV network power center of the present invention in a wired network.

FIG. 8B is a block diagram of an exemplary system using the AV network power center of the present invention in a power line network.

FIG. 9 is a block diagram of an exemplary system using multiple AV network power centers of the present invention in a wireless network.

### DETAILED DESCRIPTION OF SELECTED EMBODIMENTS

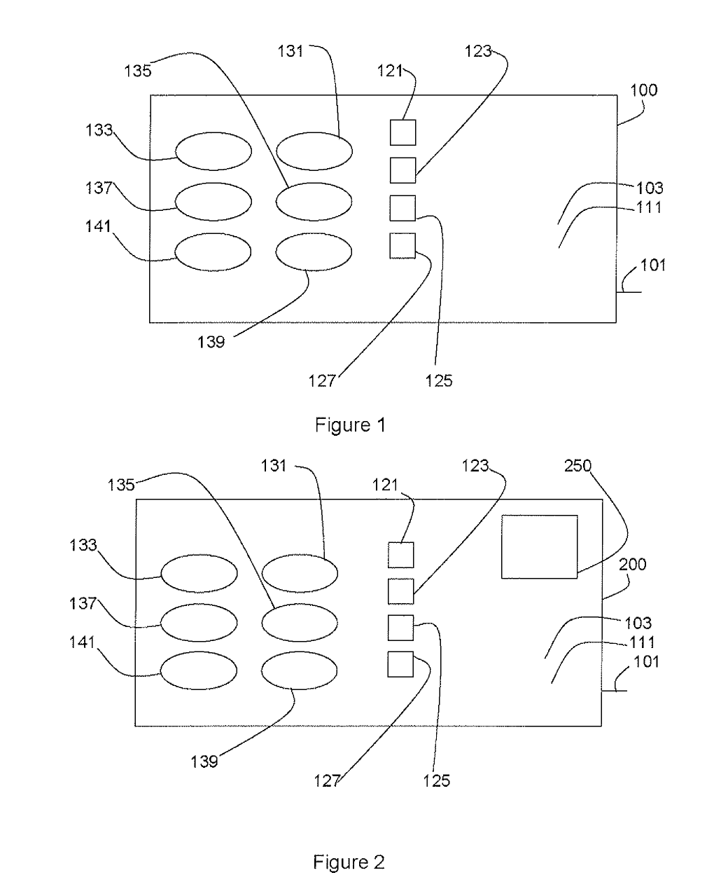

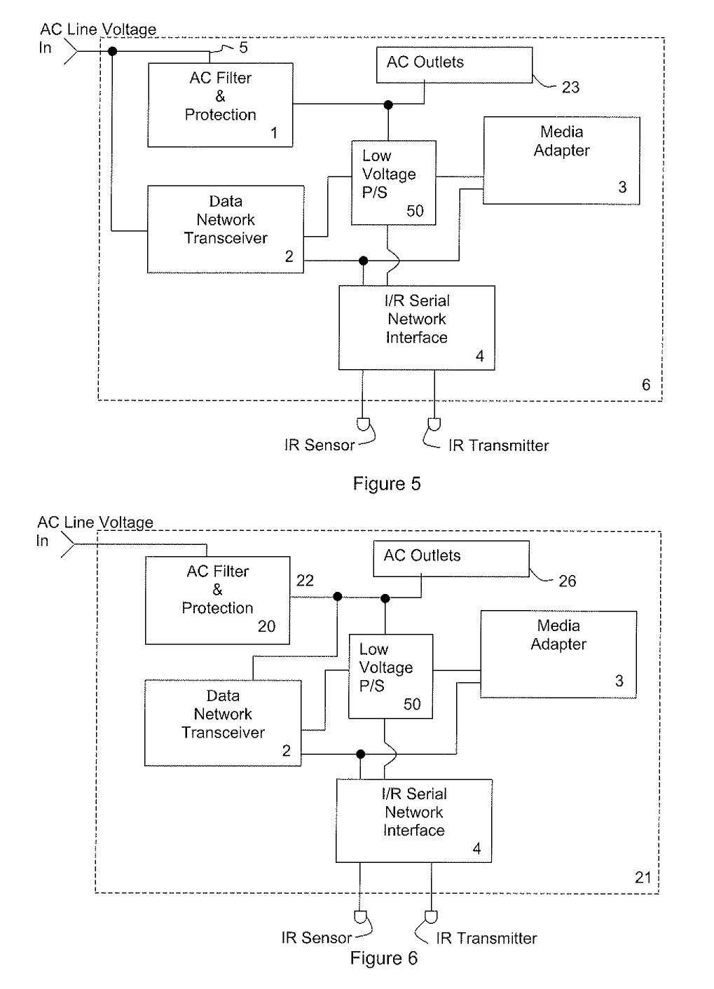

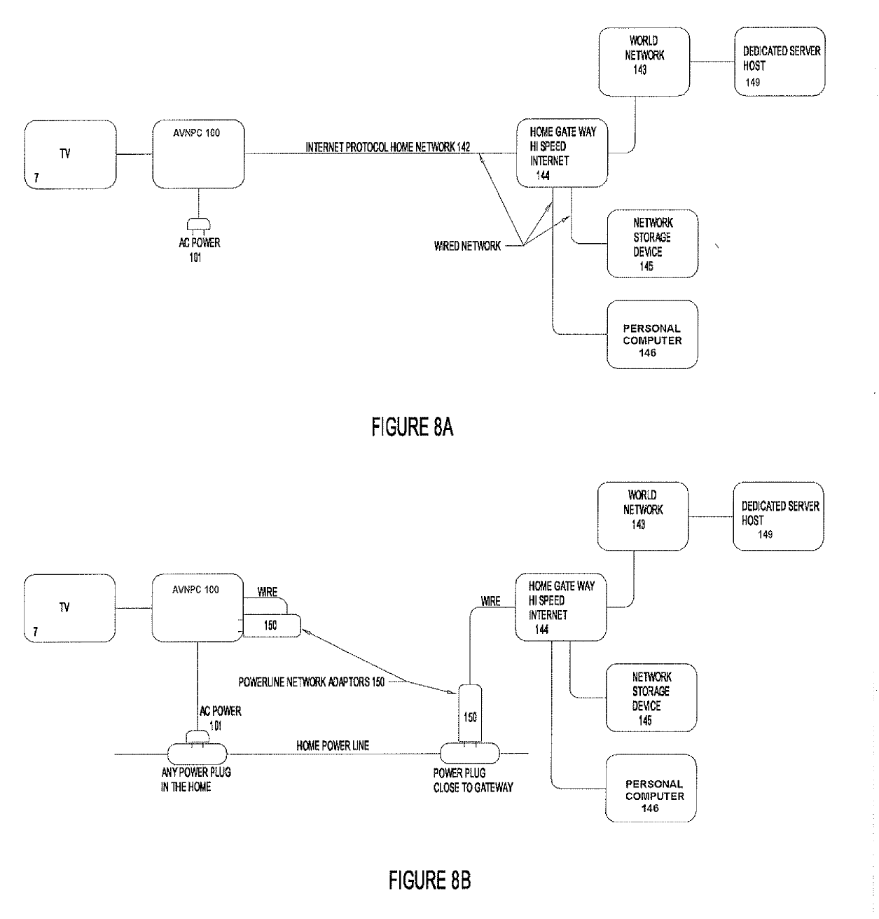

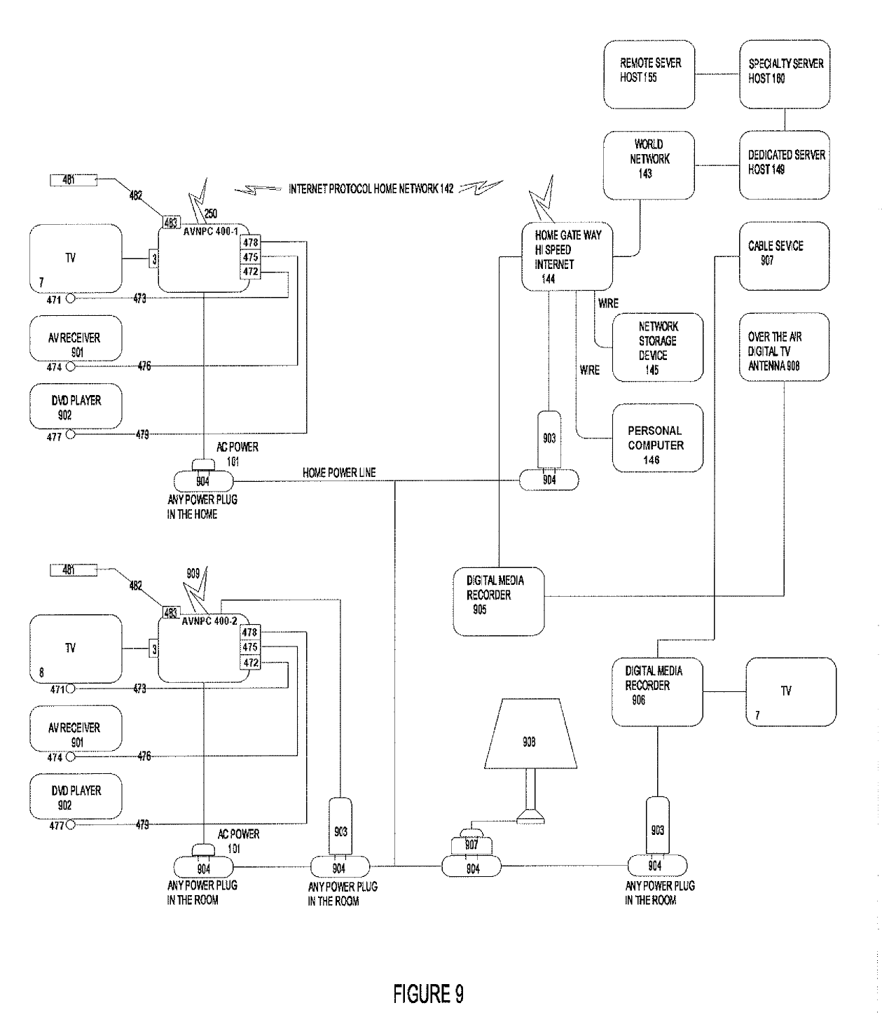

FIG. 1 illustrates, in a front view, AV network power center (AVNPC) 100. AVNPC 100 receives AC power via power cord 101. Power networking gateway 103 routes power networking data packets around power conditioning unit 111 so that networking data is provided to devices via network ports 121, 123, 125 and 127 instead of being filtered out by power conditioning unit 111. Clean, filtered power is provided individually or collectively to connected devices via outlets 131, 133, 135, 137, 139 and 141. A wired device 100, for example, could provide wired networking circuitry capable of cooperating with powerline networking, HomePlug, HDPLC and Ethernet. The AVNPC 100 will deliver media from an Internet protocol home network 142 or world network 143 to a video and/or audio monitor attached to it. This delivery will be both analog and digital. The output video content will be scaled to high resolution. The present invention delivers downloads of Internet protocol media content to an internal storage device in the network power center from a home network 142 or a world network 143 (as shown in FIG. 8A). The network power center will deliver media over Internet protocol from any storage device 145 or computer 146 in the network (as shown in FIGS. 5A, 5B, and 9). The network power center will automatically recognize any Internet protocol device on the home network.

In addition, the network power center will provide a graphical user interface in the form of a browser displayed on an attached video monitor or television. Via the browser, a user will be able to access all forms of media made available through the network power center. The browser will provide a menu of the various types of content available for access. To enhance the user experience, the network power center will automatically search for content on attached and networked devices, and index such content in a comprehensive manner in accordance with the type of content or as the user specifies. For example, digital music files may be aggregated and organized by artist and album, whereas movies are organized by genre and title. The network power center may access external databases to determine the identity of a media file and retrieve file information to aid in its indexing function. Through the browser, the user will thus be able to access a given type of content in an intuitive manner regardless of the actual physical location of the content files.

In another embodiment, wireless networking functionality is added, either hardwired or through an expansion slot card based accessory. With wireless networking device functionality (such as WiFi) incorporated into the power center, unintended wireless network loss due to power interrupts are avoided, and a common point of connection and content distribution for related devices such as networked computers and stand-alone devices like Personal Video Recorders for example, is obtained. Additional power ports are made available since the power supply for the wireless networking is internal to the power center itself rather than via an external power outlet.

FIG. 2 illustrates, in a front view, AVNPC 200 with WiFi functionality. AVNPC 200 receives A/C power via power cord 101. Power networking gateway 103 routes power networking data packets around power conditioning unit 111 so that networking data is provided to devices via network ports 121, 123, 125 and 127 instead of being filtered out by power conditioning unit 111. Clean, filtered power is provided to connected devices via outlets 131, 133, 135, 137, 139 and 141. Wireless (meaning not requiring any new wires) networking signals are obtained through wireless networking module 250, which may be built in or external, providing radio frequency wireless networking circuitry which is capable of cooperating, for example only, with systems such as WiFi, Bluetooth, ZigBee, Z-wave and RF. The exemplary network power center will communicate via IR but is not limited to command IR control over Internet protocol to any other network power center in the home network to perform a command-and-control repeater function for devices located in the same room as the network power center. The network power center may include, but is not limited to, a radio mesh network system for control of lights and automated home controls.

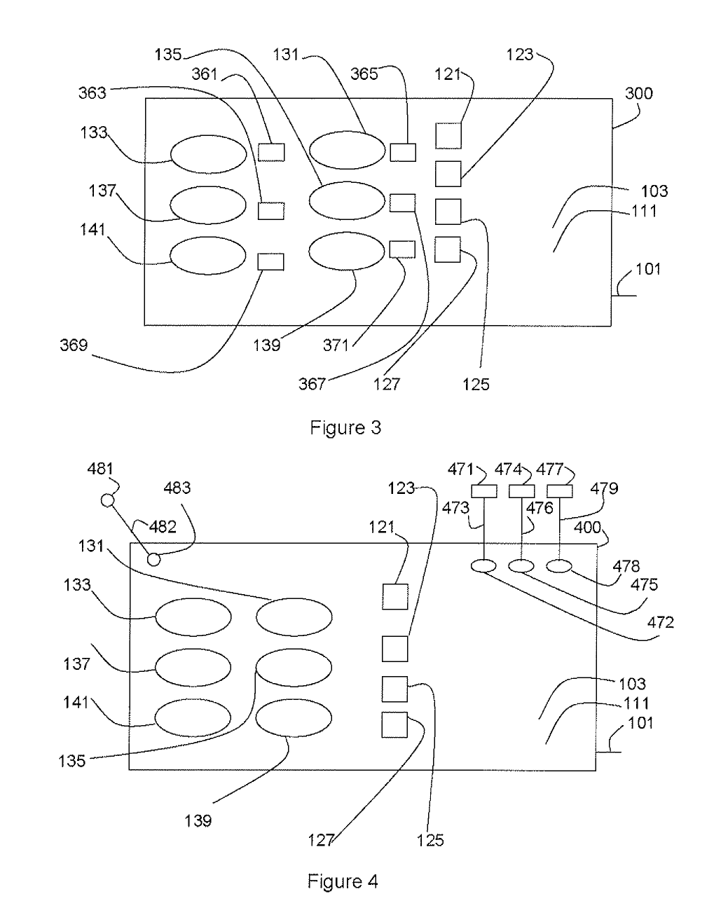

FIG. 3 illustrates AVNPC 300 with advanced power monitoring functionality. AVNPC 300 receives A/C power via power cord 101. Power networking gateway 103 routes power networking data packets around power conditioning unit 111 so that networking data is provided to devices via network ports 121, 123, 125 and 127 instead of being filtered out by power conditioning unit 111. Clean, filtered power is provided to connected devices via outlets 131, 133, 135, 137, 139 and 141. Power characteristics are monitored and managed by power monitor 345 and power characteristics are displayed on corresponding power displays 361, 363, 365, 367, 369 and 371.

In another embodiment of the present invention, an enhanced power center device incorporates, in addition to monitoring voltage characteristics for protection in a passive form, active “outlet-by-outlet” monitoring with or without a display which reports protected device power consumption and other power characteristics, as well as offering active power control of particular products. The resulting individual load status monitoring allows for information gathering, reporting and control by the central power center, both from the locally powered products as well as by remote powered products whose control signals would be blocked by traditional power filtering systems. In addition to AC line filter surge protector functionality, circuitry monitors the incoming as well as outgoing power characteristics and keeps track of power quality events defined as circumstances where the power failed to meet the expected quality level. Examples of failures to meet expected quality levels include surges, spikes, power dropouts, sags, noise on the power line and conceivable distortion on the power line. All of these parameters can affect performance of the system, making recording of these events desirable from an equipment protection as well as device optimization perspective.

FIG. 4 illustrates AVNPC 400 in conjunction with IR repeater controlled ancillary component IR emitters 471,474,477. Power networking gateway 103 routes power networking data packets around power conditioning unit 111 so that networking data is provided to devices via network ports 121, 123, 125 and 127 instead of being filtered out by power conditioning unit 111. Clean, filtered power is provided to connected devices via outlets 131, 133, 135, 137, 139 and 141. Wireless signals are gathered by IR repeater 481, passed down IR repeater cable 482 and provided to device 400 via JR input 483. Ancillary component IR emitters 471, 474 and 477 are sent JR signals via IR repeater ports 472, 475 and 478 via IR repeater cables 473, 476 and 479. In another alternate embodiment, a plurality of IR repeaters gather the IR signals from the corresponding remote control (not shown). Alternatively, radio frequency (RF) components may be substituted for the IR components.

FIG. 5 details the exemplary embodiment of the device of FIG. 2. AVNPC 6 includes AC filter and protection 1, like a Monster Cable Products HT1000 connected to data network transceiver 2 for connecting data signals to Ethernet signals. Transceiver 2 may be a wired Ethernet interface, WiFi, power line, telephone or cable modem, including Intellon Homeplug AV adapter INT6000 or a DS2 DSS9010. Media adapter 3, coupled to transceiver 2, may be the same or similar to such adapters available from Pixelworks or Philips. It is possible to interface to a Zynsys Z-Wave or X-10 or similar home control interface via either media adapter 3 or a separate device contained in AV power interface 6. Not shown is the connection between the protection/filtering module which contains AC monitoring functions and either the media adapter 3 or the IR interface 4 module to make the status and condition of the AC power available to the network. IR interface module 4 is the same or similar to a Global Cache GC100. AC outlets 25 provide filtered and surge protected power to all devices powered therefrom.

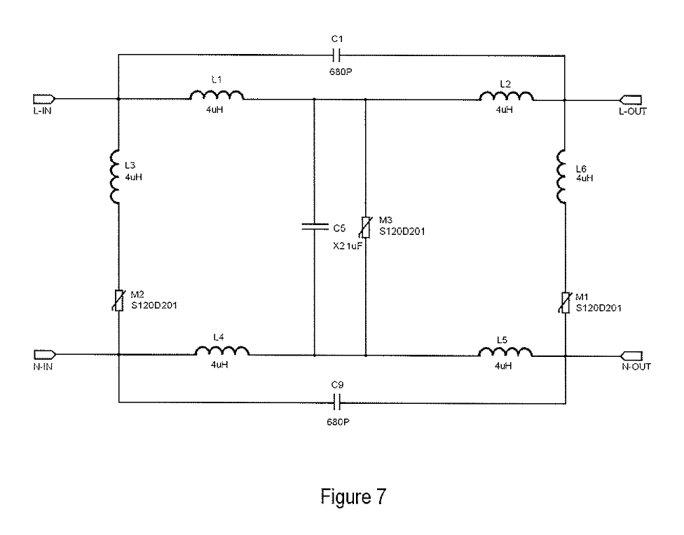

The selective filtering of module 20 permits desired control, audio, video and other coded signals present on power lines to pass through while simultaneously attenuating or entirely suppressing unwanted spurious and noise signals also present on the same power line. Referring to FIG. 6, filter module 20 provides such selectively filtered power to the other components of AVNPC 21, thus facilitating power line communications. Low voltage power supply 50 receives filtered power from module 20 to provide low voltage power to modules 2, 3 and 4. An exemplary circuit for module 20 is given in FIG. 7, and forms no part of the present invention.

Dedicated or remote household devices communicate over the power line from AVNPC 6 which is the distribution point for AV equipment throughout the system. The AVNPC 6 of the present invention can optimize the connection pathway for content-provider information such as from a satellite company or a cable company, whether it is power line, wireless or other future form of data pathway. By centralizing the data gateway in the AVNPC 6, protected devices are not saddled with cost to support networking technologies that are not needed or are not appropriate for a particular application. The network power center can download content from the Internet; this content can be shared with any other network power center in the home network. The network power center may include TV tuners or attached TV tuners, but is not limited to TV tuners, to allow such content to be downloaded to local storage and or stream over Internet protocol to any or all network power centers in the home network. Each network power center in the home network can stream, communicate, and download media or content from each other or from the Internet. The network power centers and a home network when attached to the Internet can work with or without Digital Rights Management (DRM). The network power center may also access services paid or free from the Internet.

FIG. 8A illustrates the AVNPC of FIG. 1 in a wired network system. AVNPC 100 includes AC filter and protection, like a Monster Cable Products HT1000, and is connected to the data Internet protocol home network 142 connecting data signals to the Home gateway hi speed internet 144. Other devices like but not limited to network storage device 145 and personal computer 146 are connected to the home network 142 and accessible from the AVNPC 100 via the home network 142. The home gateway 144 which forms the home network would connect to the world network 143 and make expanded services available to the home network 142, such as from a dedicated server host 149.

FIG. 8b illustrates the AVNPC of FIG. 1 in a power line network system, with the connection to the home network being realized by the use of Intellon Homeplug AV adapter Int600 or DS2 DSS9010 (powerline network adapter 150) or other similar device built into the AVNPC 100 or as an external adapter.

FIG. 9 illustrates use of AVNPC 400 of FIG. 4 in a system with multiple AVNPC's and methods of connecting them to the home network. AVNPC 400-1 is connected to TV 7 from the media adapter interface 3, receives IR signals via the IR input 483, and receives AC power 101. AVNPC 400-1 connects to a Home gateway 144 via a WiFi or similar wireless network through wireless networking module 250. It is also possible to connect directly with the Ethernet interface in AVNPC 400-1. The PC can be used to supply content or for remote control of the AVNPC 400-1. IR cable 473 connects from IR repeater port 472 on AVNPC 400-1 to IR emitter 471. This provides IR control of the TV from the AVNPC to form an integrated system. This is duplicated for the AV Receiver and the DVD player. It is also possible to interconnect multiple AVNPC's like device 400-2 such that they can share content and be controlled from each other. AVNPC 400-2 is connected to the home network with the use of Power line network adapter 903. It is further possible to add a Digital Media Recorder (DMR) 906 that will allow TV content and a common graphic user interface to be shared with all AVNPC's in the home network. It is further possible for the AVNPC 400-2 to access the World Wide Web (WWW) through a broadband Home gateway 144 via Powerline network adapter 903, WiFi, wired Ethernet or other networking media. From the WWW it is possible to access other media from a dedicated server host 149 for the system or from general purpose hosts that have content compatible with the AVNPC 400-2. It is further possible to use powerline network adapter 903 as a gateway/connection point for other services within the home that are operated or monitored from remote server hosts like 155 or specialty server host 160 that can monitor security in the home or offer remote control of the home via the control interfaces. The present invention provides the capability for home automation with command and control, Z-wave 909 from remote control and IP to control lights 908 with a Z-wave light mogul7, also IR over P from WiFi or other means to control devices on the network in the same room having an AVNPC, or any room with an appropriately configured radio. While this embodiment focuses on a powerline network, the same principles are applicable to any network medium.

To complement the enhanced functionality of the claimed device, additional enhancements include the incorporation of remote device control repeater functionality. Commonly, protected devices are enclosed within cabinetry or housing so that they are visually screened from the user. A direct consequence of housing consumer electronics devices is the impediment of remote control signals such as IR passing from the user to the product to be controlled. To expand the functionality of the present invention when enhanced with IR functionality, the present invention also incorporates an infrared repeating system when the system is programmed or designed to direct the IR commands to the specific product to which the IR commands need to go. By incorporating control signal repeater functionality in or connected with the present invention, control signals can be picked up by remote repeater modules 481, routed through the enhanced power center device and provided to the product to be controlled. The present invention may further include an IR repeater directly connected with the power control component.

In one alternate embodiment, IR cables and components are color-coded based on functionality so that corresponding IR repeater cable matching and power outlet selection is a straightforward process. To further improve device management the IR output devices (controllers) may be color coded so that the products may be managed intelligently. By way of example, color-coding or text-labeling is used at each end of the product cable to indicate the connected product. The color-coding or text designation allows for identifying the corresponding product with particular commands associated with it. Consequently, based on the designation the user would be able to tell which connected IR repeater or IR transmitter device is the one that is actually connected with the desired product. By way of example, by color coding the IR output of a DVD controller orange, as well as color coding the corresponding IR repeater cable for the DVD, the user will be able to determine the functionality of the controller when installing the product at the Power Center, as well as knowing which IR controller will control the product. Color coding related components eliminates the potential confusion and bafflement of connecting everything up and not having it work because the IR commands are not being routed to the correct product.

Information as herein shown and described in detail is fully capable of attaining the above-described object of the invention, and is, thus, representative of the subject matter which is broadly contemplated by the present invention. The scope of the present invention fully encompasses other embodiments which may become obvious to those skilled in the art, and is to be limited, accordingly, by nothing other than the appended claims, in which reference to an element in the singular is not intended to mean “one and only one” unless explicitly so stated, but rather “one or more.”

All structural and functional equivalents to and combinations of the elements of the above-described preferred embodiment and additional embodiments that are known to those of ordinary skill in the art are hereby expressly incorporated by reference and are intended to be encompassed by the present claims. However, it should be readily apparent to those of ordinary skill in the art that various changes and modifications in form, apparatus material, and fabrication material detail may be made without departing from the spirit and scope of the invention as set forth in the appended claims.

Moreover, no requirement exists for a device or method to address each and every problem sought to be resolved by the present invention, for such to be encompassed by the present claims. Furthermore, no element, component, or method step in the present disclosure is intended to be dedicated to the public regardless of whether the element, component, or method step is explicitly recited in the claims. No claim herein is to be construed under the provisions of 35 U.S.C. §?112, sixth paragraph, unless the element is expressly recited using the phrase “means for.”

### INDUSTRIAL APPLICABILITY

The present invention applies industrially to consumer electronic products protection and control. More particularly, the present invention applies to protection of such products from undesirable power conditions, while retaining the full data capability of the connected products. Even more particularly, the present invention applies to enhanced power protection devices which differentiate between undesirable power conditions and desired signals which are to be passed through the protection device in unaltered form.

What is claimed:

1. An apparatus for providing power filtering and protection, and for providing data functionality, said apparatus comprising:
an AC power filter for receiving AC power;
a plurality of AC power outlets, coupled to the AC power filter, for providing filtered and protected AC power to devices connected thereto;
a data network transceiver, coupled to the AC power filter;
a media adapter, coupled to the AC power filter and to the power line modem; and
said data network transceiver and media adapter both providing data functionality.

2. An apparatus, as recited in claim 1, wherein said data is transmitted at the AC power outlets and via wireless interface.

3. An apparatus, as recited in claim 1, further including an IR serial interface having data ports and coupled to the AC power filter, to the power line modem, and to the media adapter.

4. An apparatus as recited in claim 1 further comprising:
power management circuitry; and
power reporting displays corresponding to individual power outlets.

5. An apparatus, as recited in claim 1, additionally comprising IR repeater sensors and IR repeater outputs.

6. An apparatus, as recited in claim 5, wherein said IR repeater sensors are color-coded.

7. An apparatus, as recited in claim 5, additionally comprising IR repeater cables.

8. An apparatus, as recited in claim 1, additionally comprising wired networking circuitry wherein said wired networking circuitry is selected from the group consisting of powerline networking, HomePlus, HDPLC and Ethernet.

9. An apparatus, as recited in claim 1, additionally comprising radio frequency wireless networking circuitry which is selected from the group consisting of WiFi, Bluetooth, ZigBee, Z-wave and RF.

10. A method of providing input power protection to audio/visual devices comprising:
filtering the input power to abate undesirable power conditions; and
routing AV data around the power filters.

11. The apparatus of claim 1, additionally comprising:
network data ports;
filtered power outlets, power management circuitry; and
server means for tracking the status and history of power events.

12. The apparatus of claim 11, additionally comprising one or more power reporting displays corresponding to individual power outlets for reporting the status and history of power related events.

13. The apparatus of claim 11, additionally comprising an IR repeater on the power protection apparatus.

14. The method of claim 10, further including the steps of monitoring, tracking and reporting output power status.

15. An apparatus as recited in claim 1, wherein the data network transceiver is selected from a group consisting of a wired Ethernet interface, a WiFi modem, a power line modem, a telephone modem and a cable TV modem.

16. An apparatus as recited in claim 1, wherein said data network transceiver communicates with and receives content from a device selected from the group consisting of a digital media recorder, a personal computer, and a remote server.

17. An apparatus as recited in claim 1, further comprising a graphical user interface displayed on an attached video display for browsing and accessing media content via said data network transceiver.

18. An apparatus as recited in claim 17, further comprising processing means for searching and indexing said media content via said data network transceiver.
